(19) United States
(12) Patent Application Publication
(10) Pub. No.: US 2025/0330857 A1
(43) Pub. Date: Oct. 23, 2025

(54) ENHANCED GNSS MEASUREMENT FOR IOT NTN

(71) Applicant: Apple Inc., Cupertino, CA (US)

(72) Inventors: Chunhai Yao, Beijing (CN); Chunxuan Ye, San Diego, CA (US); Dawei Zhang, Saratoga, CA (US); Hong He, San Jose, CA (US); Oghenekome Oteri, San Diego, CA (US); Wei Zeng, Saratoga, CA (US); Haitong Sun, Saratoga, CA (US); Yushu Zhang, Beijing (CN); Weidong Yang, San Diego, CA (US); Sigen Ye, San Diego, CA (US)

(73) Assignee: Apple Inc., Cupertino, CA (US)

(21) Appl. No.: 18/860,621

(22) PCT Filed: Apr. 27, 2022
(86) PCT No.: PCT/CN2022/089575

§ 371 Date: Oct. 25, 2024

(51) Int. Cl. H04W 24/10; H04W 12/63; H04W 64/00; H04W 76/28

(52) U.S. Cl. CPC H04W 24/10; H04W 12/63; H04W 64/00; H04W 76/28

(57) ABSTRACT

Provided is a method for a user equipment (UE). The method includes detecting a status of a Global Navigation Satellite System (GNSS) position fix for the UE; in accordance with a determination that the GNSS position fix for the UE is invalid, generating, for transmission to a network device, a first GNSS measurement parameter including a first GNSS measurement periodicity and a first GNSS measurement gap; receiving, from the network device, a second GNSS measurement parameter including a second GNSS measurement gap; and performing a GNSS measurement based on the received second GNSS measurement parameter, for acquiring a valid GNSS new position fix, wherein the UE remains in Radio Resource Control (RRC)_Connected mode.

### TECHNICAL FIELD

This application relates generally to wireless communication systems, and more specifically to enhanced Global Navigation Satellite System (GNSS) measurement for Internet of Things (IoT) Non-terrestrial Network (NTN).

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method for a user equipment (UE) is provided that includes: detecting a status of a Global Navigation Satellite System (GNSS) position fix for the UE; in accordance with a determination that the GNSS position fix for the UE is invalid, generating, for transmission to a network device, a first GNSS measurement parameter including a first ONSS measurement periodicity and a first ONSS measurement gap; receiving, from the network device, a second GNSS measurement parameter including a second GNSS measurement gap; and performing a GNSS measurement based on the received second GNSS measurement parameter, for acquiring a valid GNSS new position fix, wherein the UE remains in Radio Resource Control (RRC)_Connected mode.

According to an aspect of the present disclosure, a method for a network device is provided that includes: receiving, from a user equipment (UE), a first Global Navigation Satellite System (GNSS) measurement parameter including a first GNSS measurement periodicity and a first GNSS measurement gap; generating, for transmission to the UE, a second GNSS measurement parameter including a second GNSS measurement gap; and generating a trigger for a GNSS measurement for transmission to the UE, wherein the GNSS measurement is performed in Radio Resource Control (RRC)_Connected mode of the UE based on the second GNSS measurement parameter, for acquiring a valid GNSS new position fix.

According to an aspect of the present disclosure, an apparatus for a user equipment (UE) is provided that includes one or more processors configured to perform steps of the method according to the present disclosure.

According to an aspect of the present disclosure, an apparatus for a network device is provided that includes one or more processors configured to perform steps of the method according to the present disclosure.

According to an aspect of the present disclosure, a computer readable medium is provided that has computer programs stored thereon, which when executed by one or more processors, cause an apparatus to perform steps of the method according to the present disclosure.

According to an aspect of the present disclosure, an apparatus for a communication device is provided that includes means for performing steps of the method according to the present disclosure.

According to an aspect of the present disclosure, a computer program product is provided that includes computer programs which, when executed by one or more processors, cause an apparatus to perform steps of the method according to the present disclosure.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments of the present disclosure.

FIG. 2 illustrates a flowchart of an exemplary method for a user equipment in accordance with some embodiments of the present disclosure.

FIG. 3 illustrates an exemplary diagram of determining a starting time of a Global Navigation Satellite System (GNSS) measurement gap based on the GNSS measurement parameters received from a network device in accordance with some embodiments of the present disclosure.

FIG. 4A illustrates an exemplary diagram showing the GNSS measurement periodicity and the PUSCH repetitions over time in accordance with some embodiments of the present disclosure.

FIG. 4B illustrates an exemplary diagram showing dropping the PUSCH repetitions collided with the GNSS measurement gap in accordance with some embodiments of the present disclosure.

FIG. 4C illustrates an exemplary diagram showing postponing the PUSCH repetitions collided with the GNSS measurement gap in accordance with some embodiments of the present disclosure.

FIG. 4D illustrates another exemplary diagram showing dropping the PUSCH repetitions collided with the GNSS measurement gap in accordance with some embodiments of the present disclosure.

FIG. 5 illustrates a flowchart of another exemplary method for a user equipment in accordance with some embodiments of the present disclosure.

FIG. 6A illustrates an exemplary diagram showing performing the GNSS measurement based on a time slot gap between the starting time of the on-duration period and the end time of the GNSS measurement gap in the GNSS measurement periodicity which is just before the on-duration period in accordance with some embodiments of the present disclosure.

FIG. 6B illustrates another exemplary diagram showing performing the GNSS measurement based on a time slot gap between the starting time of the on-duration period and the end time of the GNSS measurement gap in the GNSS measurement periodicity which is just before the on-duration period in accordance with some embodiments of the present disclosure.

FIG. 7 illustrates a flowchart of an exemplary method for a network device in accordance with some embodiments of the present disclosure.

FIG. 8 illustrates a flowchart of exemplary steps for GNSS measurement in accordance with some embodiments of the present disclosure.

FIG. 9 illustrates an exemplary block diagram of an apparatus for a UE in accordance with some embodiments of the present disclosure.

FIG. 10 illustrates an exemplary block diagram of an apparatus for a network device in accordance with some embodiments of the present disclosure.

FIG. 11 illustrates example components of a device in accordance with some embodiments of the present disclosure.

FIG. 12 illustrates example interfaces of baseband circuitry in accordance with some embodiments of the present disclosure.

FIG. 13 illustrates components in accordance with some embodiments of the present disclosure.

FIG. 14 illustrates an architecture of a wireless network in accordance with some embodiments of the present disclosure.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In wireless communication, Internet of Things (IoT) is attracting more and more attention. In order to better support application of IoT devices, a new research is directed to IoT support for Non-Terrestrial Network (NTN). Especially in areas where base stations cannot be built up or are damaged, such as continuous coverage in remote areas, deserts, oceans, and forests, or emergency communications when base stations are damaged in disasters, NTN may facilitate a broad IoT coverage.

For enhancement of the IoT-NTN performance, an accurate Global Navigation Satellite System (GNSS) position fix for a UE is desired. In related technologies, for sporadic short transmission, the UE acquires a GNSS position fix every time UE wakes up from an idle mode, accesses the network, performs uplink (UL) and/or downlink (DL) communications for a short duration and goes back to the idle mode. In general, since the duration of UL and/or DL communications is relative short, the acquired GNSS position fix remains valid during the transmission period. As a result, the UE does not need to re-acquire a GNSS new position fix. However, in the case of long connection, the UE is required to go back to idle mode from the connected mode and re-acquire a GNSS new position fix every time the GNSS position fix is invalid, for example due to a change in relative position of the UE and the satellites, which results in more frequent transitions between UE modes and an increased power consumption.

In view of the above, methods, apparatuses, computer readable media and computer program products for improving GNSS measurement for a new position fix for the UE are provided according to a plurality of embodiments of the present disclosure, which will be described in detail below.

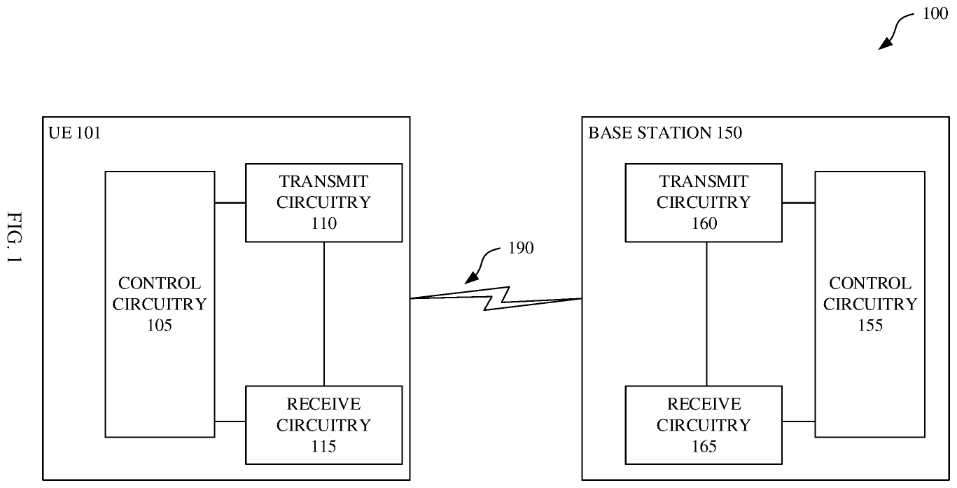

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations of may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuity 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an aplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

In various embodiments, the UE 101 and the base station 150 described with reference to FIG. 1 may be configured in various ways to implement the UE and the network device described herein.

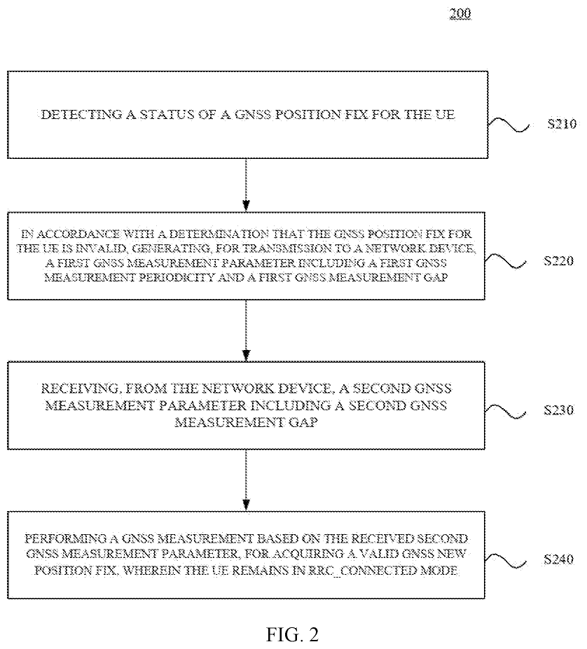

FIG. 2 illustrates a flowchart of an exemplary method for a user equipment in accordance with some embodiments of the present disclosure. The method illustrated in FIG. 2 may be implemented by the UE 101 described with reference to FIG. 1.

Referring FIG. 2, in some embodiments, the method 200 for UE may include the following steps: S210, detecting a status of a Global Navigation Satellite System (GNSS) position fix for the UE; S220, in accordance with a determination that the GNSS position fix for the UE is invalid, generating, for transmission to a network device, a first GNSS measurement parameter including a first GNSS measurement periodicity and a first GNSS measurement gap; S230, receiving, from the network device, a second GNSS measurement parameter including a second GNSS measurement gap; and S240, performing a ONSS measurement based on the received second GNSS measurement parameter, for acquiring a valid GNSS new position fix, wherein the UE remains in Radio Resource Control (RRC)_Connected mode.

According to some embodiments of the present disclosure, by generating a preferred GNSS measurement parameter for transmission to a network device and performing a GNSS measurement based on the measurement parameter received from the network, while the UE remains in RRC_Connected mode, a more suitable measurement parameter for performing the GNSS measurement by the UE may be provided, thereby facilitating a more accurate ONSS position fix for the UE. Further, frequent transitions between the UE modes such as between an idle mode and RRC_Connected mode may be avoided, which reduces latency and power consumption and therefore improves operation performance of the UE.

In some embodiments, at Step S220, generating, for transmission to the network device, the first GNSS measurement parameter including the first GNSS measurement periodicity and the first GNSS measurement gap may include generating the first GNSS measurement parameter based on at least one of a moving velocity of the UE and information associated with satellite.

According to some embodiments, the information associated with the satellite may include at least one of a moving velocity of the satellite and a coverage of the satellite.

According to some embodiments, a higher relative moving velocity between the UE and the satellite may result in a smaller validity duration of the GNSS position fix for the UE. In this case, the GNSS measurement periodicity generated by the UE may be relatively small.

According to some other embodiments, a smaller coverage of the satellite and a higher moving velocity of the UE may result in a smaller validity duration of the GNSS position fix for the UE. In this case, the GNSS measurement periodicity generated by the UE may be relatively small.

For example, the GNSS measurement periodicity generated by the UE may be selected from a group consist of 10 s, 20 s, 30 s, 40 s, 50 s, 60 s, 5 min, 10 min, 15 min, 20 min, 25 min, 30 min, 60 min, 90 min, 120 min and infinity. When the UE and the satellite remain relatively stationary, the UE may set the GNSS measurement periodicity to infinity.

According to some embodiments, the GNSS measurement gap generated by the UE may depend on the GNSS measurement periodicity generated by the UE. For example, the UE may set the GNSS measurement gap to be smaller than the GNSS measurement periodicity. According to some other embodiments, the UE may generate the GNSS measurement gap based on the location of the UB. For example, when the UE is located in a relatively open area, it is possible for UE to acquire a new position fix quickly, and accordingly, the GNSS measurement gap may be relatively small. According to yet other embodiments, the UE may generate the GNSS measurement gap based on the stored information about the satellite. For example, in the case of cold fix, since there is no associated information about the satellite stored in the UE, the UE may require a larger GNSS measurement gap for acquiring a new position fix, and in the case of warm fix, since the information about the satellite is available for the UE, the UE may require a smaller GNSS measurement gap for acquiring a new GNSS new position fix.

For example, the UE may set the ONSS measurement gap to be 2 s, 5 s, 10 s, 20 s, 30 s, etc.

It should be noted that the above values of the GNSS measurement periodicity and the GNSS measurement gap are for the purposes of illustration rather than limitation. The UE may generate any suitable GNSS measurement periodicity and GNSS measurement gap according to its own capabilities, locations and different requirements.

According to some embodiments, the UE may generate multiple pairs of GNSS measurement periodicity and GNSS measurement gap for transmission to the network device.

By generating the GNSS measurement periodicity and the GNSS measurement gap for transmission to the network device based on the information associated with the UE and the satellite, more appropriate GNSS measurement parameters can be configured by the network device that meet the requirements and capabilities of the UE, which facilitates a more accurate GNSS position fix for the UE.

In some embodiments, the second GNSS measurement parameter may further include a second GNSS measurement periodicity and a subframe offset, and the Step S240 of performing the GNSS measurement based on the received second GNSS measurement parameter may comprise: determining a starting time of the second GNSS measurement gap based on the second GNSS measurement periodicity and the subframe offset; and performing the GNSS measurement based on the determined starting time of the second GNSS measurement gap and the second GNSS measurement gap.

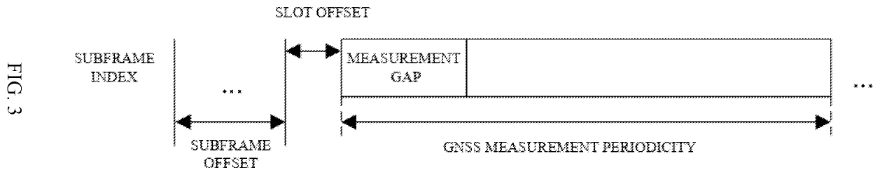

FIG. 3 illustrates an exemplary diagram of determining the starting time of the GNSS measurement gap based on the GNSS measurement parameters received from the network device in accordance with some embodiments of the present disclosure. In FIG. 3, it is assumed that the starting time of the GNSS measurement gap is aligned with the starting time of the GNSS measurement periodicity.

According to some embodiments, a slot offset of a subframe may be 0. Accordingly, the starting time of the GNSS measurement gap may be determined based on the GNSS measurement periodicity and the subframe offset received from the network device according to the following formula:

[(SFN×10)+subframe number]modulo (GNSS measurement periodicity)=subframe offset
wherein SFN denotes system frame number and 10 denotes the number of the subframes in each of the system frame. By multiplying SFN by 10, SFN is changed to the subframe level. Further, it should be noted that the GNSS measurement periodicity and the subframe offset are both in subframe level.

For the purpose of illustration rather than limitation, the GNSS measurement periodicity may be 1000 ms, and the subframe offset may be 12. Accordingly, the starting time of the received GNSS measurement gap can be determined based on the calculated SEN index (i.e., 1) and the subframe number (i.e., 2).

According to some other embodiments, the UE may further receive the slot offset of the subframe included in the second GNSS measurement parameter indicating a shift of the GNSS measurement periodicity within the subframe. Accordingly, the starting time of the GNSS measurement gap may be determined based on the GNSS measurement periodicity, the subframe offset and the slot offset of the subframe.

In some embodiments, the method 200 for the UE may further include: determining whether the UE is capable of simultaneously performing operations for transmission and the GNSS measurement; and in accordance with a determination that the UE is not capable of simultaneously performing the operations for transmission and the GNSS measurement, suspending uplink (UL) transmission within the second GNSS measurement gap.

Typically, there can be various UE with various operation capabilities, such as UE capable and not capable of simultaneously performing operations for transmission and the GNSS measurement. By suspending UL transmission during the GNSS measurement, the UE may be allowed to firstly acquire a valid GNSS new position fix and then transmit data or information based on the valid GNSS new position fix, thereby improving the accuracy of data transmission. Further, the power consumption can be reduced.

In some embodiments, suspending the UL transmission within the second GNSS measurement gap may include not scheduling Physical Uplink Control Channel (PUCCH) and Physical Uplink Shared Channel (PUSCH) within the second GNSS measurement gap, since for the UE, a GNSS new position fix may have a higher priority than data transmission through the PUCCH and the PUSCH.

In some other embodiments, there may be PUSCH repetitions and at least one of the PUSCH repetitions may be colliding with the second GNSS measurement gap. Accordingly, suspending the UL transmission within the second GNSS measurement gap may include at least one of: dropping the at least one of the PUSCH repetitions collided with the second GNSS measurement gap; postponing the at least one of the PUSCH repetitions collided with the second GNSS measurement gap and the remaining PUSCH repetitions which are scheduled after the at least one of the PUSCH repetitions; and dropping the at least one of the PUSCH repetitions collided within the second GNSS measurement gap and the remaining PUSCH repetitions which are scheduled after the at least one of the PUSCH repetitions.

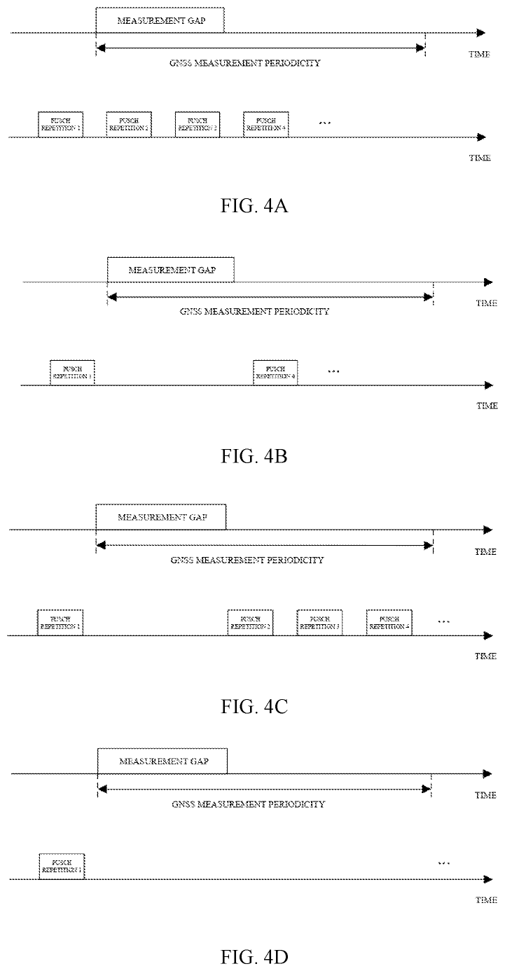

Various embodiments of suspending UL transmission within the GNSS measurement gap will be described in detail below with reference to FIGS. 4A to 4D.

FIG. 4A illustrates an exemplary diagram showing the GNSS measurement periodicity and the PUSCH repetitions over time in accordance with some embodiments of the present disclosure. For the purpose of illustration, the GNSS measurement periodicity with the GNSS measurement gap and the PUSCH repetitions are shown with two time axes, respectively. In FIG. 4A, PUSCH repetition 1 has been completed before the GNSS measurement gap, PUSCH repetitions 2 and 3 are colliding with the GNSS measurement gap, and PUSCH repetition 4 will be performed after the GNSS measurement gap.

FIG. 4B illustrates an exemplary diagram showing dropping the PUSCH repetitions collided with the GNSS measurement gap in accordance with some embodiments of the present disclosure. In FIG. 4B, when the UE performs the GNSS measurement within the GNSS measurement gap, the PUSCH repetitions 2-3 are dropped and the PUSCH repetition 4 out of the GNSS measurement gap will not be affected and will be performed after the GNSS measurement within the GNSS measurement gap is completed. As a result, a number of PUSCH repetitions less than the original number of PUSCH repetitions will be performed.

By dropping the PUSCH repetitions within the GNSS measurement gap, the collision between the GNSS measurement and the PUSCH repetitions may be avoided while no latency will occur.

FIG. 4C illustrates an exemplary diagram showing postponing the PUSCH repetitions collided with the GNSS measurement gap in accordance with some embodiments of the present disclosure. In FIG. 4C, the collided PUSCH repetitions 2-3 and the non-collided PUSCH repetition 4 scheduled thereafter are postponed as a whole such that they are performed after the GNSS measurement gap. As a result, a number of PUSCH repetitions equal to the original number of PUSCH repetitions will be performed.

By postponing the PUSCH repetitions within the GNSS measurement gap together with the PUSCH repetitions scheduled thereafter, the collision between the GNSS measurement and the PUSCH repetitions may be avoided while data loss can be reduced.

FIG. 4D illustrates another exemplary diagram showing dropping the PUSCH repetitions collided with the GNSS measurement gap in accordance with some embodiments of the present disclosure. In FIG. 4D, both the collided PUSCH repetitions 2-3 and the non-collided PUSCH repetition 4 scheduled thereafter are dropped. As a result, a number of PUSCH repetitions less than the original number of PUSCH repetitions will be performed.

It should be noted that although 4 PUSCH repetitions are shown with respect to FIGS. 4A-4D and 2 of the 4 PUSCH repetitions are colliding with the GNSS measurement gap, there may be a greater or lesser number of PUSCH repetitions and there may be a greater or lesser number of PUSCH repetitions collided with the GNSS measurement gap.

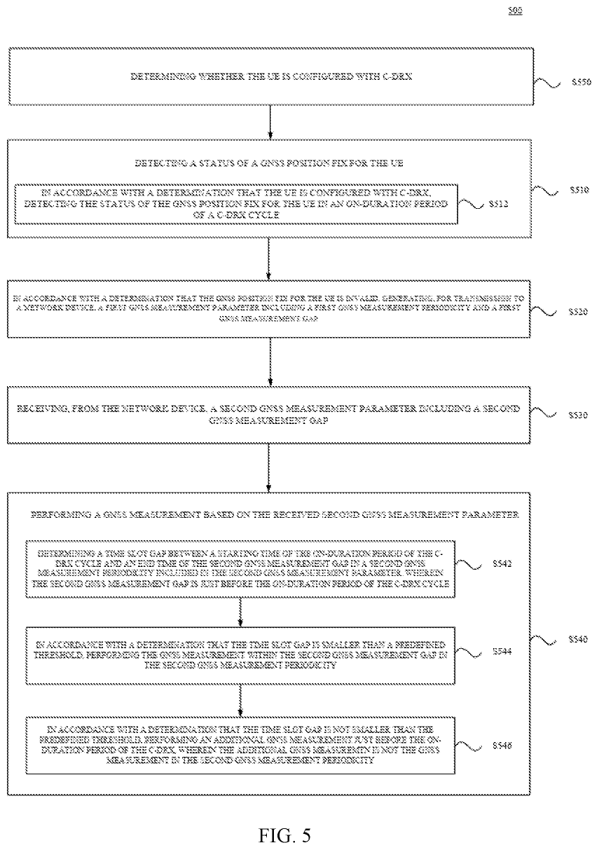

FIG. 5 illustrates a flowchart of another exemplary method 500 for a user equipment in accordance with some embodiments of the present disclosure. The method illustrated in FIG. 5 may also be implemented by the UE 101 described with reference to FIG. 1.

Referring FIG. 5, in some embodiments, the method 500 for UE may include the following steps: S510-S540 which are same as or similar to Steps S210-S240 illustrated in FIGS. 2, and S550, determining whether the UE is configured with Connected-Discontinuous Reception (C-DRX), and wherein the Step SS10 of detecting the status of the GNSS position fix for the UE may include Step S512, in accordance with a determination that the UE is configured with C-DRX, detecting the status of the GNSS position fix for the UE in an on-duration period of a C-DRX cycle, and wherein the Step S540 of performing the GNSS measurement based on the received second GNSS measurement parameter may include the following steps: S542, determining a time slot gap between a starting time of the on-duration period of the C-DRX cycle and an end time of the second GNSS measurement gap in a second GNSS measurement periodicity included in the second GNSS measurement parameter, wherein the second GNSS measurement gap is just before the on-duration period of the C-DRX cycle; S544, in accordance with a determination that the time slot gap is smaller than a predefined threshold, performing the GNSS measurement within the second GNSS measurement gap in the second GNSS measurement periodicity; and S546, in accordance with a determination that the time slot gap is not smaller than the predefined threshold, performing an additional GNSS measurement just before the on-duration period of the C-DRX, wherein the additional GNSS measurement is not the GNSS measurement in the second GNSS measurement periodicity.

It should be appreciated that for the specific implementations and benefits of the Steps S510-540, reference can be made to the above-described embodiments corresponding to the Steps S210-S240.

According to some embodiments, the predefined threshold may be any suitable value that matches the capabilities of the UB and meets the requirements for the UE operations. For example. the predefined threshold may be set to 5 ms, 10 ms, 20 ms, 30 ms, etc.

By configuring the UE with C-DRX, the power can be saved due to the low power consumption during the sleep period of the C-DRX cycle. Further, by determining the validity of the GNSS position fix for the UE in the on-duration period and performing the GNSS measurement based on a time slot gap between the starting time of the on-duration period and the end time of the GNSS measurement gap in the second GNSS measurement periodicity which is just before the on-duration period, it can be ensured that the GNSS position fix for the UE remains valid in the on-duration period.

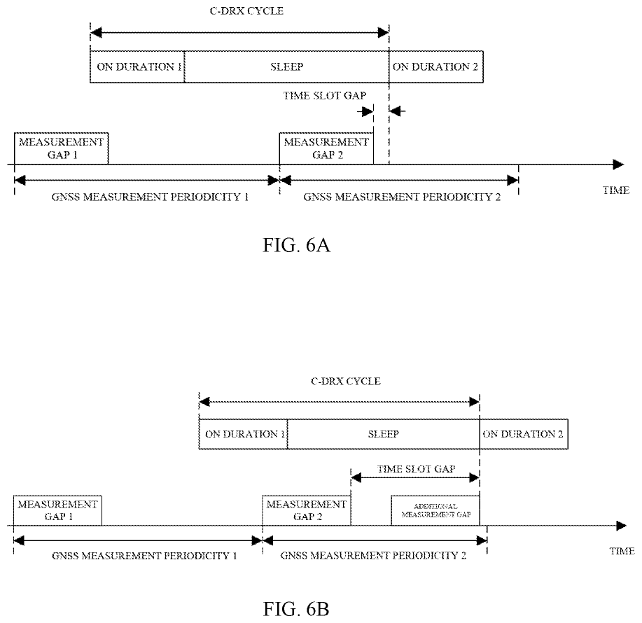

FIG. 6A illustrates an exemplary diagram showing performing the GNSS measurement based on the time slot gap between the starting time of the on-duration period and the end time of the GNSS measurement gap in the second GNSS measurement periodicity which is just before the on-duration period in accordance with some embodiments of the present disclosure.

According to some embodiments, in FIG. 6A, the on-duration and sleep period of the C-DRX cycle and the GNSS measurement periodicities over time are shown. Further, the time slot gap between the starting time of the on-duration period 2 and the end time of the GNSS measurement gap 2 just before the on-duration period 2 is determined to be smaller than the predefined threshold. In this case, the UE performs the GNSS measurement within the GNSS measurement gap 2 in the GNSS measurement periodicity 2 for acquiring a valid GNSS new position fix for the UE operations within the on-duration period 2 of the C-DRX cycle.

According to some other embodiments, the GNSS measurements in the remaining GNSS measurement periodicities within a sleep period of the C-DRX cycle (not shown) are suspended in this case, i.e., when the time slot gap is smaller than the predefined threshold.

By suspending the GNSS measurements in the remaining GNSS measurement periodicities within the sleep period of the C-DRX cycle, a frequent update of the GNSS position fix for the UE can be avoided, which is unnecessary since UE will not operate during this period. As a result, the power consumption of the UE can be reduced.

FIG. 6B illustrates another exemplary diagram showing performing the GNSS measurement based on the time slot gap between the starting time of the on-duration period and the end time of the GNSS measurement gap in the second GNSS measurement periodicity which is just before the on-duration period in accordance with some embodiments of the present disclosure.

According to some embodiments, similar to FIG. 6A, the on-duration and sleep period of the C-DRX cycle and the GNSS measurement periodicities over time are shown in FIG. 6B. In FIG. 6B, the time slot gap between the starting time of the on-duration period 2 and the end time of the GNSS measurement gap 2 just before the on-duration period 2 is determined to be not smaller than the predefined threshold. In this case, the GNSS position fix for the UE acquired from the GNSS measurement within the GNSS measurement gap 2 in the GNSS measurement periodicity 2 will not remain valid for the whole on-duration period. Therefore, an additional GNSS measurement is performed within a GNSS measurement gap other than that within the GNSS measurement periodicity.

According to some other embodiments, the GNSS measurements in the GNSS measurement periodicities within a sleep period of the C-DRX cycle are suspended in this case, i.e., when the time slot gap is not smaller than the predefined threshold.

Similar to the embodiments illustrated with respect to FIG. 6A, since an additional GNSS measurement is performed for acquiring a GNSS new position fix for the UE operations within the on-duration period, the GNSS measurements in the measurement periodicities within the sleep period are unnecessary. As a result, suspending such GNSS measurements can facilitate reduced power consumption.

In some embodiments, the additional GNSS measurement may be triggered by paging information including an indication of triggering the additional GNSS measurement, and wherein the method 500 for the UE may further include receiving the paging information from the network device.

In some other embodiments, the additional GNSS measurement may be triggered by the starting time of the on-duration period of the C-DRX cycle such that the additional GNSS measurement is performed during a sleep period in a previous C-DRX cycle and completed just before the starting time of the on-duration period of the C-DRX cycle. In this way, it can be ensured that the GNSS position fix for the UE is latest and valid at the starting time of the on-duration period of the C-DRX cycle.

In some embodiments, the on-duration period of the C-DRX cycle may be greater than the GNSS measurement periodicity. In this case, the GNSS position fix for the UE may be outdated during the on-duration period of the C-DRX cycle, and therefore another GNSS measurement may be necessary.

In order to acquire a GNSS new position fix for the UE, the method 500 for the UE may further include: in accordance with a determination that the UB is configured with C-DRX, comparing the on-duration period of the C-DRX cycle with a duration of the second GNSS measurement periodicity, and wherein performing the GNSS measurement based on the received second GNSS measurement parameter may comprise: in accordance with a determination that the on-duration period of the C-DRX cycle is greater than the duration of the second GNSS measurement periodicity, shifting the second GNSS measurement gap within the on-duration period of the C-DRX based on the additional GNSS measurement gap.

By shifting the GNSS measurement gap within the on-duration period based on the additional GNSS measurement gap, a valid GNSS new position fix for the UE may be acquired in time so as to prevent a reduced UE performance. Further, it can be avoided that a GNSS measurement is performed in the validity duration of the position fix.

As discussed above, the GNSS position fix for the UE may be outdated during an on-duration period of the C-DRX cycle greater than the GNSS measurement periodicity. In some other embodiments, in order to acquire a GNSS new position fix for the UE, the method 200 for the UE may further include: determining whether the UE is configured with Connected-Discontinuous Reception (C-DRX); and in accordance with a determination that the UE is configured with C-DRX, comparing an on-duration period of a C-DRX cycle with a duration of a second GNSS measurement periodicity included in the second GNSS measurement parameter, and wherein performing the GNSS measurement based on the received second GNSS measurement parameter may comprise: in accordance with a determination that the on-duration period of the C-DRX cycle is greater than the duration of the second GNSS measurement periodicity, performing the GNSS measurement periodically within the on-duration period of the C-DRX based on the second GNSS measurement gap and the second GNSS measurement periodicity.

In some embodiments, the method 200 and/or 500 for the UE may further include detecting a trigger for the GNSS measurement, and wherein the trigger for the GNSS measurement may comprise Radio Resource Control (RRC) configuration, Downlink Control Information (DCI) or Random Access Response Uplink (UL) Grant, and wherein the second GNSS measurement parameter may be transmitted via Radio Resource Control (RRC) signaling.

In the case where the GNSS measurement is triggered by the RRC configuration, the second GNSS measurement parameter such as the GNSS measurement periodicity, the GNSS measurement gap, the subframe offset and the slot offset of the subframe may be transmitted via the RRC signaling, and the GNSS measurement is performed once the RRC configuration is received by the UE. An advantage of such a trigger mechanism for the GNSS measurement is that a GNSS measurement can be performed in time once the position fix is invalid.

However, the UE is not required to always perform a GNSS measurement once the GNSS position fix for it is invalid. Especially in the case where the UE is in long connection and configured with C-DRX for the power saving purpose, frequent GNSS measurements and frequent updating of the GNSS position fix for the UE are not desired during the sleep period.

According to some embodiments, in order to reducing unnecessary operations of UE and power consumption, the UE may receive the RRC configuration including the GNSS measurement parameters via the RRC signaling but perform the GNSS measurement until a DCI is received which includes a field to indicate the GNSS measurement. The filed indicating to perform the GNSS measurement may be for example, one or more new fields introduced or existing one or more fields reinterpreted.

According to some other embodiments, UB may receive the RRC configuration including the GNSS measurement parameters via the RRC signaling but consider a received RAR UL Grant as a trigger for the GNSS measurement, which includes a field to indicate the GNSS measurement. Similarly, the field indicating to perform the GNSS measurement may be for example one field reinterpreted for GNSS measurement triggering, such as a Channel State Information (CSI) request field.

According to yet other embodiments, the trigger for the GNSS measurement may comprise Medium Access Control (MAC) Control Element (CE) and in this case, the second GNSS measurement parameter such as the GNSS measurement periodicity, the GNSS measurement gap, the subframe offset and the slot offset of the subframe is defined in the MAC CE. Similarly, the MAC CE may include one or more fields to indicate whether to perform the GNSS measurement.

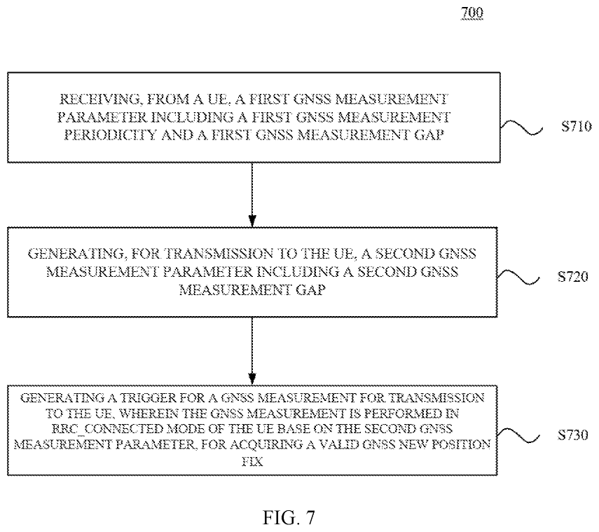

FIG. 7 illustrates a flowchart of an exemplary method 700 for a network device in accordance with some embodiments of the present disclosure. The method 700 illustrated in FIG. 7 may be implemented by the base station 150 described in FIG. 1. For example, the network device may be the network device of the base station 150.

In some embodiments, the method 700 for a network device may include the following steps: S710, receiving, from a user equipment (UE), a first Global Navigation Satellite System (GNSS) measurement parameter including a first GNSS measurement periodicity and a first GNSS measurement gap; S720, generating, for transmission to the UE, a second GNSS measurement parameter including a second GNSS measurement gap; and S730, generating a trigger for a GNSS measurement for transmission to the UE, wherein the GNSS measurement is performed in Radio Resource Control (RRC)_Connected mode of the UE based on the second GNSS measurement parameter, for acquiring a valid GNSS new position fix.

In the following, each step of the method 700 will be described. Note that those elements, expressions, features etc. that have already been described with reference to FIG. 2 and FIG. 5 and its corresponding description (about UB) are omitted herein for clarity.

At Step S710, the network device receives, from a UE, a first ONSS measurement parameter including a first GNSS measurement periodicity and a first GNSS measurement gap.

At Step S720, the network generates, for transmission to the UE, a second GNSS measurement parameter including a second GNSS measurement gap.

At Step S730, the network generates, a trigger for a GNSS measurement for transmission to the UE, wherein the GNSS measurement is performed in RRC_Connected mode of the UE based on the second GNSS measurement parameter, for acquiring a valid GNSS new position fix.

According to some embodiments of the present disclosure, by receiving a GNSS measurement parameter from the UE and configuring another GNSS measurement parameter for example, based on the received GNSS measurement parameter for performing a GNSS measurement in RRC_Connected mode of the UE, a more suitable measurement parameter for performing the GNSS measurement by the UE may be provided, thereby facilitating a more accurate GNSS position fix for the UE. Further, frequent transitions between the UE modes such as between an idle mode and RRC_Connected mode may be avoided, which reduces latency and power consumption and therefore improves operation performance of the UE.

In some embodiments, the second GNSS measurement parameter may further comprise a second GNSS measurement periodicity and a subframe offset, and the GNSS measurement may be performed based on the second ONSS measurement periodicity, the second GNSS measurement gap and the subframe offset.

In some embodiments, the trigger for the GNSS measurement may comprise Radio Resource Control (RRC) configuration, Downlink Control Information (DCI) or Random Access Response Uplink (UL) Grant, and the second GNSS measurement parameter may be transmitted via Radio Resource Control (RRC) signaling.

In some embodiments, the trigger for the GNSS measurement may comprise Medium Access Control (MAC) Control Element (CE) and the second GNSS measurement parameter may be included in the MAC CE.

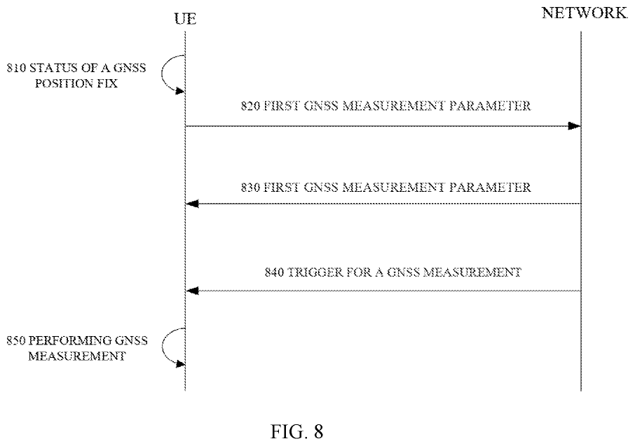

FIG. 8 illustrates a flowchart of exemplary steps for GNSS measurement in accordance with some embodiments of the present disclosure.

In FIG. 8, the steps of the method for UE and the method for network device to enhance GNSS measurement for IoT NTN are shown.

At Step 810, the UE may detect a status of a GNSS position fix for the UE. Step S810 can be implemented according to the description with reference to Step S210 and/or Step S510.

At Step 820, the UE may transmit a first GNSS measurement parameter including a first ONSS measurement periodicity and a first GNSS measurement gap to the network device in accordance with a determination that the GNSS position fix for the UE is invalid. Step S820 can be implemented according to the description with reference to Step S220, Step S520 and/or Step 710.

At Step 830, the network device may transmit a second GNSS measurement parameter including a second GNSS measurement gap to the UE. Step S830 can be implemented according to the description with reference to Step S230, Step S530 and/or Step 720.

At Step 840, the network device may transmit a trigger for a GNSS measurement to the UE. Step S840 can be implemented according to the description with reference to Step 730.

At Step 850, the UE may perform the GNSS measurement based on the received second GNSS measurement parameter, for acquiring a valid GNSS new position fix. The UE remains in Radio Resource Control (RRC)_Connected mode during the GNSS measurement. Step S850 can be implemented according to the description with reference to Step S240 and/or Step S540.

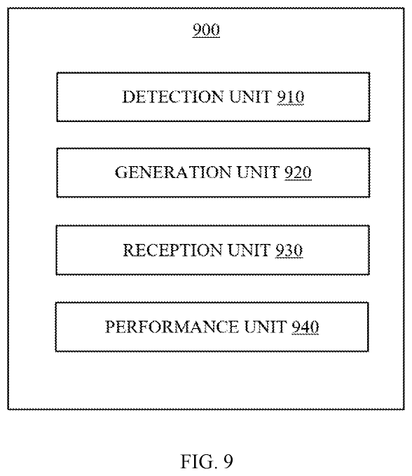

FIG. 9 illustrates an exemplary block diagram of an apparatus 900 for a UE in accordance with some embodiments of the present disclosure. The apparatus 900 illustrated in FIG. 9 may be used to implement the method 200 and the method 500 illustrated in combination with FIG. 2 and FIG. 5, respectively.

As illustrated in FIG. 9, the apparatus 900 may include a detection unit 910, a generation unit 920, a reception unit 930 and a performance unit 940.

The detection unit 910 may be configured to detect a status of a GNSS position fix for the UE. The generation unit 920 may be configured to generate, for transmission to a network device, a first GNSS measurement parameter including a first GNSS measurement periodicity and a first GNSS measurement gap in accordance with a determination that the GNSS position fix for the UE is invalid. The reception unit 930 may be configured to receive, from the network device, a second GNSS measurement parameter including a second GNSS measurement gap. The performance unit 940 may be configured to perform a GNSS measurement based on the received second GNSS measurement parameter, for acquiring a valid GNSS new position fix, wherein the UB remains in Radio Resource Control (RRC)_Connected mode.

According to some embodiments of the present disclosure, by generating a preferred GNSS measurement parameter for transmission to a network device and performing a GNSS measurement based on the measurement parameter received from the network while the UE remains in RRC_Connected mode, a more suitable measurement parameter for performing the GNSS measurement by the UE may be provided, thereby facilitating a more accurate GNSS position fix for the UB. Further, frequent transitions between the UE modes such as between an idle mode and RRC_Connected mode may be avoided, which reduces latency and power consumption and therefore improves operation performance of the UE.

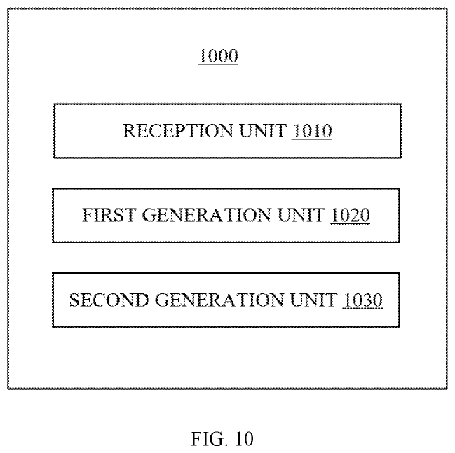

FIG. 10 illustrates an exemplary block diagram of an apparatus 1000 for a network device in accordance with some embodiments of the present disclosure. The apparatus 1000 illustrated in FIG. 10 may be used to implement the method 700 as illustrated in combination with FIG. 7.

As illustrated in FIG. 10, the apparatus 1000 may include a reception unit 1010, a first generation unit 1020 and a second generation unit 1030.

The reception unit 1010 may be configured to receive, from a user equipment (UE), a first Global Navigation Satellite System (GNSS) measurement parameter including a first GNSS measurement periodicity and a first GNSS measurement gap. The first generation unit 1020 may be configured to generate, for transmission to the UB, a second GNSS measurement parameter including a second GNSS measurement gap. The second generation unit 1030 may be configured to generate a trigger for a GNSS measurement for transmission to the UE, wherein the GNSS measurement is performed in Radio Resource Control (RRC)_Connected mode of the UE based on the second GNSS measurement parameter, for acquiring a valid GNSS new position fix.

According to some embodiments of the present disclosure, by receiving a GNSS measurement parameter from the UE and configuring another GNSS measurement parameter for example, based on the received GNSS measurement parameter for performing a GNSS measurement in RRC_Connected mode of the UE, a more suitable measurement parameter for performing the GNSS measurement by the UE may be provided, thereby facilitating a more accurate GNSS position fix for the UE. Further, frequent transitions between the UE modes such as between an idle mode and RRC_Connected mode may be avoided, which reduces latency and power consumption and therefore improves operation performance of the UE.

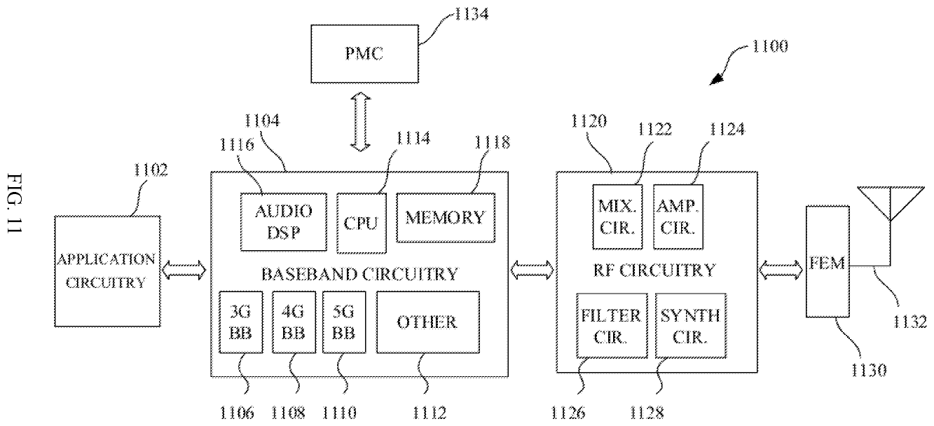

FIG. 11 illustrates example components of a device 1100 in accordance with some embodiments of the present disclosure. In some embodiments, the device 1100 may include application circuitry 1102, baseband circuitry 1104, Radio Frequency (RF) circuitry (shown as RF circuitry 1120), front-end module (FEM) circuitry (shown as FEM circuitry 1130), one or more antennas 1132, and power management circuitry (PMC) (shown as PMC 1134) coupled together at least as shown. The components of the illustrated device 1100 may be included in a UE or a RAN node. In some embodiments, the device 1100 may include fewer elements (e.g., a RAN node may not utilize application circuitry 1102, and instead include a processor/controller to process IP data received from an EPC). In some embodiments, the device 1100 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1102 may include one or more application processors. For example, the application circuitry 1102 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1100. In some embodiments, processors of application circuitry 1102 may process IP data packets received from an EPC.

The baseband circuitry 1104 may include circuitry such as, but not limited to, one or more single-core or multi-core processors. The baseband circuitry 1104 may include one or more baseband processors or control logic to process baseband signals received from a receive signal path of the RF circuitry 1120 and to generate baseband signals for a transmit signal path of the RF circuitry 1120. The baseband circuitry 1104 may interface with the application circuitry 1102 for generation and processing of the baseband signals and for controlling operations of the RF circuitry 1120. For example, in some embodiments, the baseband circuitry 1104 may include a third generation (3G) baseband processor (3G baseband processor 1106), a fourth generation (4G) baseband processor (4G baseband processor 1108), a fifth generation (5G) baseband processor (5G baseband processor 1110), or other baseband processor(s) 1112 for other existing generations, generations in development or to be developed in the future (e.g., second generation (2G), sixth generation (6G), etc.). The baseband circuitry 1104 (e.g., one or more of baseband processors) may handle various radio control functions that enable communication with one or more radio networks via the RF circuitry 1120. In other embodiments, some or all of the functionality of the illustrated baseband processors may be included in modules stored in the memory 1118 and executed via a Central Processing ETnit (CPET 1114). The radio control functions may include, but are not limited to, signal modulation/demodulation, encoding/decoding, radio frequency shifting, etc. In some embodiments, modulation/demodulation circuitry of the baseband circuitry 1104 may include Fast-Fourier Transform (FFT), precoding, or constellation mapping/demapping functionality. In some embodiments, encoding/decoding circuitry of the baseband circuitry 1104 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1104 may include a digital signal processor (DSP), such as one or more audio DSP(s) 1116. The one or more audio DSP(s) 1116 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1104 and the application circuitry 1102 may be implemented together such as, for example. on a system on a chip (SOC).

In some embodiments, the baseband circuitry 1104 may provide for communication compatible with one or more radio technologies. For example, in some embodiments, the baseband circuitry 1104 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1104 is configured to support radio communications of more than one wireless protocol may be referred to as multi-mode baseband circuitry.

The RF circuitry 1120 may enable communication with wireless networks using modulated electromagnetic radiation through a non-solid medium. In various embodiments, the RF circuitry 1120 may include switches, filters, amplifiers, etc. to facilitate the communication with the wireless network. The RF circuitry 1120 may include a receive signal path which may include circuitry to down-convert RF signals received from the FEM circuitry 1130 and provide baseband signals to the baseband circuitry 1104. The RF circuitry 1120 may also include a transmit signal path which may include circuitry to up-convert baseband signals provided by the baseband circuitry 1104 and provide RF output signals to the FEM circuitry 1130 for transmission. In some embodiments, the receive signal path of the RF circuitry 1120 may include mixer circuitry 1122, amplifier circuitry 1124 and filter circuitry 1126. In some embodiments, the transmit signal path of the RF circuitry 1120 may include filter circuitry 1126 and mixer circuitry 1122. The RF circuitry 1120 may also include synthesizer circuitry 1128 for synthesizing a frequency for use by the mixer circuitry 1122 of the receive signal path and the transmit signal path. In some embodiments, the mixer circuitry 1122 of the receive signal path may be configured to down-convert RF signals received from the FEM circuitry 1130 based on the synthesized frequency provided by synthesizer circuitry 1128. The amplifier circuitry 1124 may be configured to amplify the down-converted signals and the filter circuitry 1126 may be a low-pass filter (LPF) or band-pass filter (BPF) configured to remove unwanted signals from the down-converted signals to generate output baseband signals. Output baseband signals may be provided to the baseband circuitry 1104 for further processing. In some embodiments, the output baseband signals may be zero-frequency baseband signals, although this is not a requirement. In some embodiments, the mixer circuitry 1122 of the receive signal path may comprise passive mixers, although the scope of the embodiments is not limited in this respect.

In some embodiments, the mixer circuitry 1122 of the transmit signal path may be configured to up-convert input baseband signals based on the synthesized frequency provided by the synthesizer circuitry 1128 to generate RF output signals for the FEM circuitry 1130. The baseband signals may be provided by the baseband circuitry 1104 and may be filtered by the filter circuitry 1126.

In some embodiments, the mixer circuitry 1122 of the receive signal path and the mixer circuitry 1122 of the transmit signal path may include two or more mixers and may be arranged for quadrature downconversion and upconversion, respectively. In some embodiments, the mixer circuitry 1122 of the receive signal path and the mixer circuitry 1122 of the transmit signal path may include two or more mixers and may be arranged for image rejection (e.g., Hartley image rejection). In some embodiments, the mixer circuitry 1122 of the receive signal path and the mixer circuitry 1122 may be arranged for direct downconversion and direct upconversion, respectively. In some embodiments, the mixer circuitry 1122 of the receive signal path and the mixer circuitry 1122 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1120 may include analog-to-digital converter (ADC) and digital-to-analog converter (DAC) circuitry and the baseband circuitry 1104 may include a digital baseband interface to communicate with the RF circuitry 1120.

In some dual-mode embodiments, a separate radio IC circuitry may be provided for processing signals for each spectrum, although the scope of the embodiments is not limited in this respect.

In some embodiments, the synthesizer circuitry 1128 may be a fractional-N synthesizer or a fractional N/N+1 synthesizer, although the scope of the embodiments is not limited in this respect as other types of frequency synthesizers may be suitable. For example, synthesizer circuitry 1128 may be a delta-sigma synthesizer, a frequency multiplier, or a synthesizer comprising a phase-locked loop with a frequency divider.

The synthesizer circuitry 1128 may be configured to synthesize an output frequency for use by the mixer circuitry 1122 of the RF circuitry 1120 based on a frequency input and a divider control input. In some embodiments, the synthesizer circuitry 1128 may be a fractional N/N+1 synthesizer.

In some embodiments, frequency input may be provided by a voltage controlled oscillator (VCO), although that is not a requirement. Divider control input may be provided by either the baseband circuitry 1104 or the application circuitry 1102 (such as an applications processor) depending on the desired output frequency. In some embodiments, a divider control input (e.g., N) may be determined from a look-up table based on a channel indicated by the application circuitry 1102.

Synthesizer circuitry 1128 of the RF circuitry 1120 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1128 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1120 may include an IQ/polar converter.

The FEM circuitry 1130 may include a receive signal path which may include circuitry configured to operate on RF signals received from one or more antennas 1132, amplify the received signals and provide the amplified versions of the received signals to the RF circuitry 1120 for further processing. The FEM circuitry 1130 may also include a transmit signal path which may include circuitry configured to amplify signals for transmission provided by the RF circuitry 1120 for transmission by one or more of the one or more antennas 1132. In various embodiments, the amplification through the transmit or receive signal paths may be done solely in the RF circuitry 1120, solely in the FEM circuitry 1130, or in both the RF circuitry 1120 and the FEM circuitry 1130.

In some embodiments, the FEM circuitry 1130 may include a TX/RX switch to switch between transmit mode and receive mode operation. The FEM circuitry 1130 may include a receive signal path and a transmit signal path. The receive signal path of the FEM circuitry 1130 may include an LNA to amplify received RF signals and provide the amplified received RF signals as an output (e.g., to the RF circuitry 1120). The transmit signal path of the PEM circuitry 1130 may include a power amplifier (PA) to amplify input RF signals (e.g., provided by the RF circuitry 1120), and one or more filters to generate RF signals for subsequent transmission (e.g., by one or more of the one or more antennas 1132).

In some embodiments, the PMC 1134 may manage power provided to the baseband circuitry 1104. In particular, the PMC 1134 may control power-source selection, voltage scaling, battery charging, or DC-to-DC conversion. The PMC 1134 may often be included when the device 1100 is capable of being powered by a battery, for example, when the device 1100 is included in a EGE. The PMC 1134 may increase the power conversion efficiency while providing desirable implementation size and heat dissipation characteristics.

FIG. 11 shows the PMC 1134 coupled only with the baseband circuitry 1104. However, in other embodiments, the PMC 1134 may be additionally or alternatively coupled with, and perform similar power management operations for, other components such as, but not limited to, the application circuitry 1102, the RF circuitry 1120, or the FEM circuitry 1130.

In some embodiments, the PMC 1134 may control, or otherwise be part of, various power saving mechanisms of the device 1100. For example, if the device 1100 is in an RRC Connected state, where it is still connected to the RAN node as it expects to receive traffic shortly, then it may enter a state known as Discontinuous Reception Mode (DRX) after a period of inactivity. During this state, the device 1100 may power down for brief intervals of time and thus save power.

If there is no data traffic activity for an extended period of time, then the device 1100 may transition off to an RRC Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1102 and processors of the baseband circuitry 1104 may be used to execute elements of one or more instances of a protocol stack. For example, processors of the baseband circuitry 1104, alone or in combination, may be used to execute Layer 3, Layer 2, or Layer 1 functionality, while processors of the application circuitry 1102 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

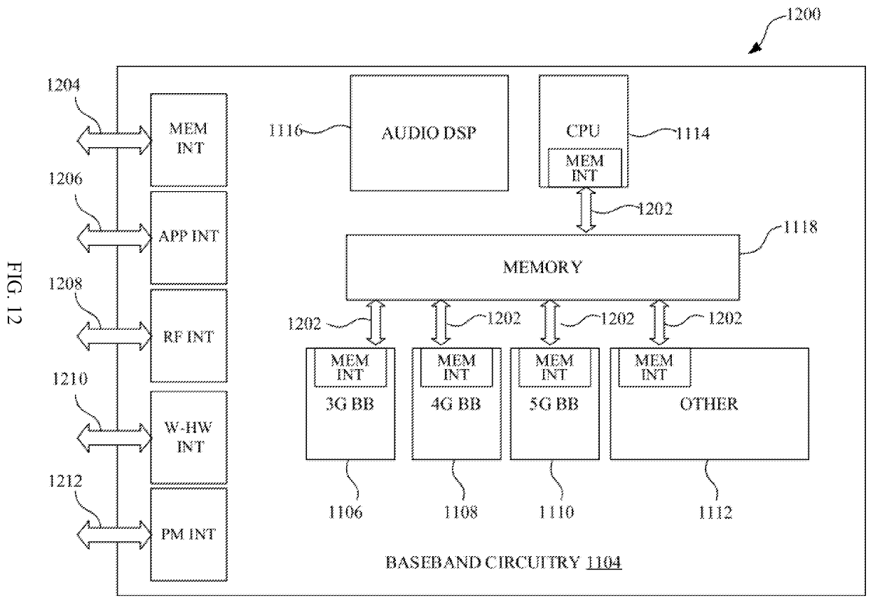

FIG. 12 illustrates example interfaces 1200 of baseband circuitry in accordance with some embodiments. As discussed above, the baseband circuitry 1104 of FIG. 11 may comprise 3G baseband processor 1106, 4G baseband processor 1108, 5G baseband processor 1110, other baseband processor(s) 1112, CPU 1114, and a memory 1118 utilized by said processors. As illustrated, each of the processors may include a respective memory interface 1202 to send/receive data to/from the memory 1118.

The baseband circuitry 1104 may further include one or more interfaces to communicatively couple to other circuitries/devices, such as a memory interface 1204 (e.g., an interface to send/receive data to/from memory external to the baseband circuitry 1104), an application circuitry interface 1206 (e.g., an interface to send/receive data to/from the application circuitry 1102 of FIG. 11), an RF circuitry interface 1208 (e.g., an interface to send/receive data to/from RF circuitry 1120 of FIG. 11), a wireless hardware connectivity interface 1210 (e.g., an interface to send/receive data to/from Near Field Communication (NFC) components, Bluetooth® components (e.g., Bluetooth® Low Energy), Wi-Fi® components, and other communication components), and a power management interface 1212 (e.g., an interface to send/receive power or control signals to/from the PMC 1134).

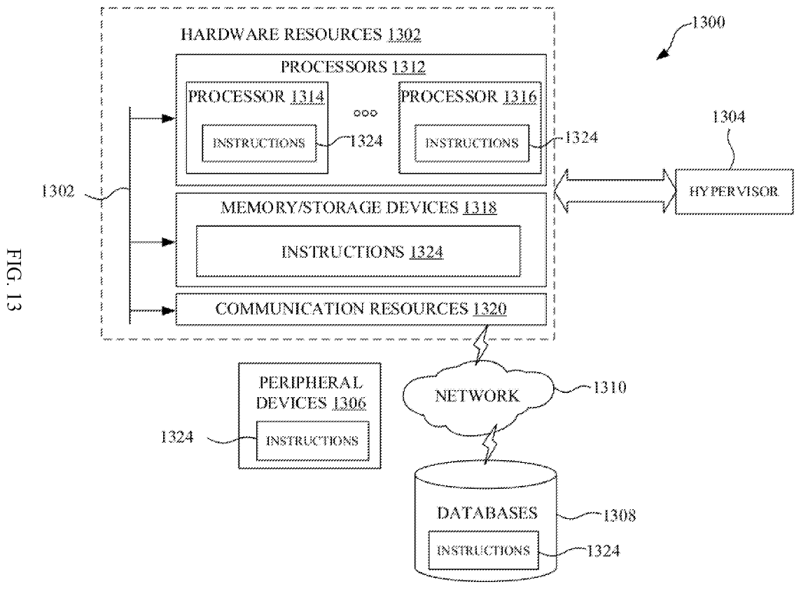

FIG. 13 is a block diagram illustrating components 1300, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1302 including one or more processors 1312 (or processor cores), one or more memory/storage devices 1318, and one or more communication resources 1320, each of which may be communicatively coupled via a bus 1322. For embodiments where node virtualization (e.g., NFV) is utilized, a hypervisor 1304 may be executed to provide an execution environment for one or more network slices/sub-slices to utilize the hardware resources 1302.

The processors 1312 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1314 and a processor 1316.

The memory/storage devices 1318 may include main memory, disk storage, or any suitable combination thereof. The memory/storage devices 1318 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1320 may include interconnection or network interface components or other suitable devices to communicate with one or more peripheral devices 1306 or one or more databases 1308 via a network 1310. For example, the communication resources 1320 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1324 may comprise software, a program, an application, an applet, an app, or other executable code for causing at least any of the processors 1312 to perform any one or more of the methodologies discussed herein. The instructions 1324 may reside, completely or partially, within at least one of the processors 1312 (e.g., within the processor's cache memory), the memory/storage devices 1318, or any suitable combination thereof. Furthermore, any portion of the instructions 1324 may be transferred to the hardware resources 1302 from any combination of the peripheral devices 1306 or the databases 1308. Accordingly, the memory of the processors 1312, the memory/storage devices 1318, the peripheral devices 1306, and the databases 1308 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

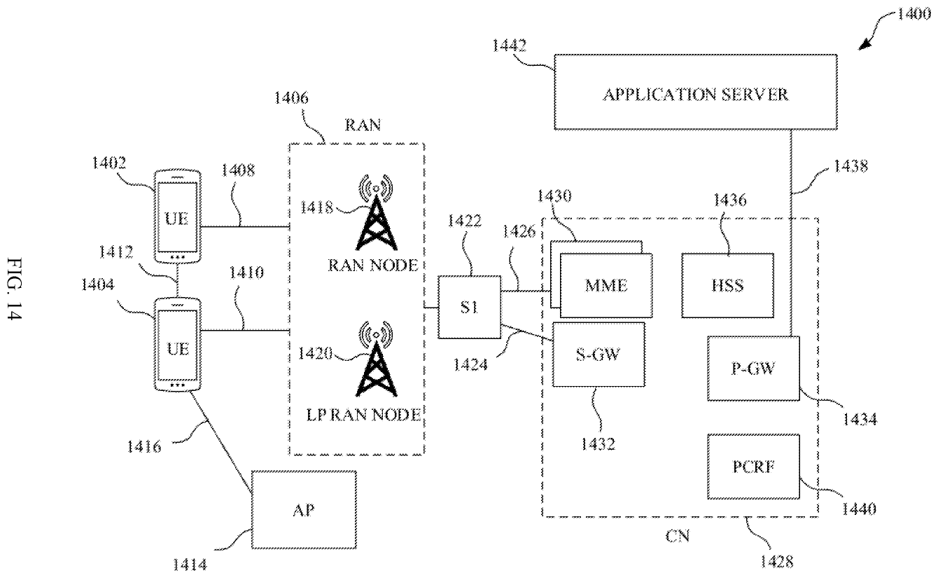

FIG. 14 illustrates an architecture of a system 1400 of a network in accordance with some embodiments. The system 1400 includes one or more user equipment (UE), shown in this example as a UE 1402 and a UB 1404. The UE 1402 and the UE 1404 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, aby of the UE 1402 and the UE 1404 can comprise an Internet of Things (IoT) UE, which can comprise a network access layer designed for low-power IoT applications utilizing short-lived UB connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. The UE 1402 and the UE 1404 may be configured to connect, e.g., communicatively couple, with a radio access network (RAN), shown as RAN 1406. The RAN 1406 may be, for example, an Evolved ETniversal Mobile Telecommunications System (ETMTS) Terrestrial Radio Access Network (B-UTRAN), a NextGen RAN (NG RAN), or some other type of RAN. The UE 1402 and the UE 1404 utilize connection 1408 and connection 1410, respectively, each of which comprises a physical communications interface or layer (discussed in further detail below); in this example, the connection 1408 and the connection 1410 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (SG) protocol, a New Radio (NR) protocol, and the like.

In this embodiment, the UE 1402 and the UE 1404 may further directly exchange communication data via a ProSe interface 1412. The ProSe interface 1412 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1404 is shown to be configured to access an access point (AP), shown as AP 1144, via connection 1416. The connection 1416 can comprise a local wireless connection, such as a connection consistent with any IEEE 802.14 protocol, wherein the AP 1414 would comprise a wireless fidelity (WiFi®) router. In this example, the AP 1414 may be connected to the Internet without connecting to the core network of the wireless system (described in further detail below).

The RAN 1406 can include one or more access nodes that enable the connection 1408 and the connection 1410. These access nodes (ANs) can be referred to as base stations (BSs), NodeBs, evolved NodeBs (eNBs), next Generation NodeBs (gNB), RAN podes, and so forth, and can comprise ground stations (e.g., terrestrial access points) or satellite stations providing coverage within a geographic area (e.g., a cell). The RAN 1406 may include one or more RAN nodes for providing macrocells, e.g., macro RAN node 1418, and one or more RAN nodes for providing femtocells or picocells (e.g., cells having smaller coverage areas, smaller user capacity, or higher bandwidth compared to macrocells), e.g., a low power (LP) RAN node such as LP RAN node 1420. Any of the macro RAN node 1418 and the LP RAN node 1420 can terminate the air interface protocol and can be the first point of contact for the UE 1402 and the UE 1404. In some embodiments, any of the macro RAN node 1418 and the LP RAN node 1420 can fulfill various logical functions for the RAN 1406 including, but not limited to, radio network controller (RNC) functions such as radio bearer management, uplink and downlink dynamic radio resource management and data packet scheduling, and mobility management.

In accordance with some embodiments, the EGE 1402 and the EGE 1404 can be configured to communicate using Orthogonal Frequency-Division Multiplexing (OFDM) communication signals with each other or with any of the macro RAN node 1418 and the LP RAN node 1420 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1418 and the LP RAN node 1420 to the UE 1402 and the UE 1404, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1402 and the UE 1404. The physical downlink control channel (PDCCH) may carry information about the transport format and resource allocations related to the PDSCH channel, among other things. It may also inform the UE 1402 and the UB 1404 about the transport format, resource allocation, and H-ARQ (Hybrid Automatic Repeat Request) information related to the uplink shared channel. Typically, downlink scheduling (assigning control and shared channel resource blocks to the UE 1404 within a cell) may be performed at any of the macro RAN node 1418 and the LP RAN node 1420 based on channel quality information fed back from any of the UE 1402 and UE 1404. The downlink resource assignment information may be sent on the PDCCH used for (e.g., assigned to) each of the UE 1402 and the UE 1404.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1406 is communicatively coupled to a core network (CN), shown as CN 1428—via an S1 interface 1422. In embodiments, the CN 1428 may be an evolved packet core (EPC) network, a NextGen Packet Core (NPC) network, or some other type of CN. In this embodiment the S1 interface 1422 is split into two parts: the S1-U interface 1424, which carries traffic data between the macro RAN node 1418 and the LP RAN node 1420 and a serving gateway (S-GW), shown as S-GW 1132, and an S1-mobility management entity (MME) interface, shown as S1-MME interface 1426, which is a signaling interface between the macro RAN node 1418 and LP RAN node 1420 and the MME(s) 1430. In this embodiment, the CN 1428 comprises the MME(s) 1430, the S-GW 1432, a Packet Data Network (PDN) Gateway (P-GW) (shown as P-GW 1434), and a home subscriber server (HSS) (shown as HSS 1436). The MME(s) 1430 may be similar in function to the control plane of legacy Serving General Packet Radio Service (GPRS) Support Nodes (SGSN). The MME(s) 1430 may manage mobility aspects in access such as gateway selection and tracking area list management. The HSS 1436 may comprise a database for network users, including subscription-related information to support the network entities' handling of communication sessions. The CN 1428 may comprise one or several HSS 1436, depending on the number of mobile subscribers, on the capacity of the equipment, on the organization of the network, etc. For example, the HSS 1436 can provide support for routing/roaming, authentication, authorization, naming/addressing resolution, location dependencies, etc.

The S-GW 1432 may terminate the S1 interface 322 towards the RAN 1406, and routes data packets between the RAN 1406 and the CN 1428. In addition, the S-GW 1432 may be a local mobility anchor point for inter-RAN node handovers and also may provide an anchor for inter-3 GPP mobility. Other responsibilities may include lawful intercept, charging, and some policy enforcement.

The P-GW 1434 may terminate an SGi interface toward a PDN. The P-GW 1434 may route data packets between the CN 1428 (e.g., an EPC network) and external networks such as a network including the application server 1442 (alternatively referred to as application function (AF)) via an Internet Protocol (IP) interface (shown as IP communications interface 1438). Generally, an application server 1442 may be an element offering applications that use IP bearer resources with the core network (e.g., ETMTS Packet Services (PS) domain, LTE PS data services, etc.). In this embodiment, the P-GW 1434 is shown to be communicatively coupled to an application server 1142 via an IP communications interface 1438. The application server 1442 can also be configured to support one or more communication services (e.g., Voice-over-Internet Protocol (VOIP) sessions, PTT sessions, group communication sessions, social networking services, etc.) for the UE 1402 and the UE 1404 via the CN 1428.

The P-GW 1434 may further be a node for policy enforcement and charging data collection. A Policy and Charging Enforcement Function (PCRF) (shown as PCRF 1440) is the policy and charging control element of the CN 1428. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN), The PCRF 1440 may be communicatively coupled to the application server 1442 via the P-GW 1434. The application server 1442 may signal the PCRF 1440 to indicate a new service flow and select the appropriate Quality of Service (QoS) and charging parameters. The PCRF 1440 may provision this rule into a Policy and Charging Enforcement Function (PCEF) (not shown) with the appropriate traffic flow template (TFT) and QoS class of identifier (QCI), which commences the QoS and charging as specified by the application server 1442.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), including: detecting a status of a Global Navigation Satellite System (GNSS) position fix for the UE; in accordance with a determination that the GNSS position fix for the UB is invalid, generating, for transmission to a network device, a first GNSS measurement parameter including a first GNSS measurement periodicity and a first GNSS measurement gap; receiving, from the network device, a second GNSS measurement parameter including a second GNSS measurement gap; and performing a GNSS measurement based on the received second GNSS measurement parameter, for acquiring a valid GNSS new position fix, wherein the UE remains in Radio Resource Control (RRC)_Connected mode.

Example 2 is the method of Example 1, wherein generating, for transmission to the network device, the first GNSS measurement parameter including the first GNSS measurement periodicity and the first GNSS measurement gap comprises: generating the first GNSS measurement parameter based on at least one of a moving velocity of the UE and information associated with satellite.

Example 3 is the method of Example 1, wherein the second GNSS measurement parameter further comprises a second GNSS measurement periodicity and a subframe offset, and performing the GNSS measurement based on the received second GNSS measurement parameter comprises: determining a starting time of the second GNSS measurement gap based on the second GNSS measurement periodicity and the subframe offset; and performing the GNSS measurement based on the determined starting time of the second GNSS measurement gap and the second GNSS measurement gap.

Example 4 is the method of any of Examples 1-3, further comprising: determining whether the UE is capable of simultaneously performing operations for transmission and the GNSS measurement; and in accordance with a determination that the UE is not capable of simultaneously performing the operations for transmission and the GNSS measurement, suspending uplink (UL) transmission within the second GNSS measurement gap.

Example 5 is the method of Example 4, wherein in accordance with the determination that the UE is not capable of simultaneously performing the operations for transmission and the GNSS measurement, suspending the UL transmission within the second GNSS measurement gap comprises: not scheduling Physical Uplink Control Channel (PUCCH) and Physical Uplink Shared Channel (PUSCH) within the second GNSS measurement gap.

Example 6 is the method of Example 4, wherein in accordance with the determination that the UE is not capable of simultaneously performing the operations for transmission and the GNSS measurement, suspending the UL transmission within the second GNSS measurement gap comprises: if there are Physical Uplink Shared Channel (PUSCH) repetitions and at least one of the PUSCH repetitions is colliding with the second GNSS measurement gap, performing at least one of: dropping the at least one of the PUSCH repetitions collided with the second GNSS measurement gap; postponing the at least one of the PUSCH repetitions collided with the second GNSS measurement gap and the remaining PUSCH repetitions which are scheduled after the at least one of the PUSCH repetitions; and dropping the at least one of the PUSCH repetitions collided within the second GNSS measurement gap and the remaining PUSCH repetitions which are scheduled after the at least one of the PUSCH repetitions.

Example 7 is the method of Example 1, further comprising: determining whether the UE is configured with Connected-Discontinuous Reception (C-DRX), and wherein detecting the status of the GNSS position fix for the UE comprises: in accordance with a determination that the UE is configured with C-DRX, detecting the status of the GNSS position fix for the UE in an on-duration period of a C-DRX cycle, and wherein performing the GNSS measurement based on the received second GNSS measurement parameter comprises: determining a time slot gap between a starting time of the on-duration period of the C-DRX cycle and an end time of the second GNSS measurement gap in a second GNSS measurement periodicity included in the second GNSS measurement parameter, wherein the second GNSS measurement gap is just before the on-duration period of the C-DRX cycle; in accordance with a determination that the time slot gap is smaller than a predefined threshold, performing the GNSS measurement within the second GNSS measurement gap in the second GNSS measurement periodicity; and in accordance with a determination that the time slot gap is not smaller than the predefined threshold, performing an additional GNSS measurement just before the on-duration period of the C-DRX, wherein the additional GNSS measurement is not the GNSS measurement in the second GNSS measurement periodicity.

Example 8 is the method of Example 7, wherein the additional GNSS measurement is triggered by paging information including an indication of triggering the additional GNSS measurement, and wherein the method further comprises: receiving the paging information from the network device.

Example 9 is the method of Example 7, wherein the additional GNSS measurement is triggered by the starting time of the on-duration period of the C-DRX cycle such that the additional GNSS measurement is performed during a sleep period in a previous C-DRX cycle and completed just before the starting time of the on-duration period of the C-DRX cycle.

Example 10 is the method of any of Examples 7-9, further comprising: in accordance with a determination that the UE is configured with C-DRX, comparing the on-duration period of the C-DRX cycle with a duration of the second GNSS measurement periodicity, and wherein performing the GNSS measurement based on the received second GNSS measurement parameter comprises: in accordance with a determination that the on-duration period of the C-DRX cycle is greater than the duration of the second GNSS measurement periodicity, shifting the second GNSS measurement gap within the on-duration period of the C-DRX based on the additional GNSS measurement gap.

Example 11 is the method of Example 1, further comprising: determining whether the UE is configured with Connected-Discontinuous Reception (C-DRX); and in accordance with a determination that the UE is configured with C-DRX, comparing an on-duration period of a C-DRX cycle with a duration of a second GNSS measurement periodicity included in the second GNSS measurement parameter, and wherein performing the GNSS measurement based on the received second ONSS measurement parameter comprises: in accordance with a determination that the on-duration period of the C-DRX cycle is greater than the duration of the second GNSS measurement periodicity, performing the ONSS measurement periodically within the on-duration period of the C-DRX based on the second GNSS measurement gap and the second GNSS measurement periodicity.

Example 12 is the method of any of Examples 7-9, wherein the GNSS measurements in the remaining second GNSS measurement periodicities within a sleep period of the C-DRX cycle are suspended when the time slot gap is smaller than the predefined threshold.

Example 13 is the method of any of Examples 7-9, wherein the GNSS measurements in the second GNSS measurement periodicities within a sleep period of the C-DRX cycle are suspended when the time slot gap is not smaller than the predefined threshold.

Example 14 is the method of any of Examples 1-3, further comprising detecting a trigger for the GNSS measurement, and wherein the trigger for the GNSS measurement comprises Radio Resource Control (RRC) configuration, Downlink Control Information (DCI) or Random Access Response Uplink (UL) Grant, and wherein the second GNSS measurement parameter is transmitted via Radio Resource Control (RRC) signaling.

Example 15 is the method of any of Examples 1-3, further comprising detecting a trigger for the GNSS measurement, and wherein the trigger for the GNSS measurement comprises Medium Access Control (MAC) Control Element (CE) and wherein the second GNSS measurement parameter is included in the MAC CE.

Example 16 is a method for a network device, comprising: receiving, from a user equipment (UE), a first Global Navigation Satellite System (GNSS) measurement parameter including a first GNSS measurement periodicity and a first GNSS measurement gap; generating, for transmission to the UE, a second GNSS measurement parameter including a second GNSS measurement gap; and generating a trigger for a GNSS measurement for transmission to the UE, wherein the GNSS measurement is performed in Radio Resource Control (RRC)_Connected mode of the UE based on the second GNSS measurement parameter, for acquiring a valid GNSS new position fix.

Example 17 is the method of Example 16, wherein the second GNSS measurement parameter further comprises a second GNSS measurement periodicity and a subframe offset, and wherein the GNSS measurement is performed based on the second GNSS measurement periodicity, the second GNSS measurement gap and the subframe offset.

Example 18 is the method of Example 16 or 17, wherein the trigger for the GNSS measurement comprises Radio Resource Control (RRC) configuration, Downlink Control Information (DCI) or Random Access Response Uplink (UL) Grant, and wherein the second GNSS measurement parameter is transmitted via Radio Resource Control (RRC) signaling.

Example 19 is the method of Example 16 or 17, wherein the trigger for the GNSS measurement comprises Medium Access Control (MAC) Control Element (CE) and wherein the second GNSS measurement parameter is included in the MAC CE.

Example 20 is an apparatus for a user equipment (UE), the apparatus comprising: one or more processors configured to perform steps of the method of any of Examples 1-16.

Example 21 is an apparatus for a network device, the apparatus comprising: one or more processors configured to perform steps of the method of any of Examples 16-19.

Example 22 is a computer readable medium having computer programs stored thereon which, when executed by one or more processors, cause an apparatus to perform steps of the method according to any of Examples 1-19.

Example 23 is an apparatus for a communication device, comprising means for performing steps of the method according to any of Examples 1-19.

Example 24 is a computer program product comprising computer programs which, when executed by one or more processors, cause an apparatus to perform steps of the method according to any of Examples 1-19.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-24. (canceled)

25. A method comprising:
receiving, from a network device, a media access control (MAC) control element (CE) that indicates one or more GNSS measurement parameters, the one or more GNSS measurement parameters including a Global Navigation Satellite System (GNSS) measurement gap; and
performing, while in a radio resource control (RRC) connected mode, a GNSS measurement based on the one or more GNSS measurement parameters.

26. The method of claim 25, further comprising:
detecting a status of a GNSS position fix for a user equipment;
determining the GNSS position fix is invalid; and
performing the GNSS measurement to acquire a valid GNSS new position fix.

27. The method of claim 25, wherein the MAC CE includes a field with an indication to perform the GNSS measurement and the method further comprises:
performing the GNSS measurement based on the indication to perform the GNSS measurement.

28. The method of claim 25, wherein the one or more GNSS measurement parameters are one or more second GNSS measurement parameters, the GNSS measurement gap is a second GNSS measurement gap, and the method further comprises:
generating, for transmission to the network device, one or more first GNSS measurement parameters based on a moving velocity of a user equipment (UE) or information associated with satellite, the one or more first GNSS measurement parameters to include a first GNSS measurement periodicity and a first GNSS measurement gap.

29. The method of claim 25, wherein the one or more GNSS measurement parameters further include a GNSS measurement periodicity and a subframe offset, and performing the GNSS measurement based on the one or more GNSS measurement parameters comprises:
determining a starting time of the GNSS measurement gap based on the GNSS measurement periodicity and the subframe offset; and
performing the GNSS measurement based on the determined starting time of the GNSS measurement gap and the GNSS measurement gap.

30. The method of claim 25, further comprising:
determining whether a user equipment (UE) is capable of simultaneously performing operations for transmission and the GNSS measurement; and
in accordance with a determination that the UE is not capable of simultaneously performing the operations for transmission and the GNSS measurement, suspending uplink (UL) transmission within the GNSS measurement gap.

31. The method of claim 30, wherein suspending the UL transmission within the GNSS measurement gap comprises:
not scheduling Physical Uplink Control Channel (PUCCH) and Physical Uplink Shared Channel (PUSCH) within the GNSS measurement gap.

32. The method of claim 30, wherein suspending the UL transmission within the GNSS measurement gap comprises:
determining there are Physical Uplink Shared Channel (PUSCH) repetitions and at least one of the PUSCH repetitions is colliding with the GNSS measurement gap; and
performing at least one of:
dropping the at least one of the PUSCH repetitions collided with the GNSS measurement gap;
postponing the at least one of the PUSCH repetitions collided with the GNSS measurement gap and the remaining PUSCH repetitions that are scheduled after the at least one of the PUSCH repetitions; or
dropping the at least one of the PUSCH repetitions collided within the GNSS measurement gap and the remaining PUSCH repetitions that are scheduled after the at least one of the PUSCH repetitions.

33. The method of claim 25, further comprising:
detecting a trigger for the GNSS measurement,
wherein the trigger for the GNSS measurement comprises Radio Resource Control (RRC) configuration, Downlink Control Information (DCI) or Random Access Response Uplink (UL) Grant.

34. An apparatus comprising:
one or more processors to:
detect a status of a Global Navigation Satellite System (GNSS) position fix for a user equipment (UE) in an on-duration period of a Connected-Discontinuous Reception (C-DRX);
in accordance with a determination that the GNSS position fix for the UE is invalid, generate, for transmission to a network device, a first GNSS measurement parameter including a first GNSS measurement periodicity and a first GNSS measurement gap;
receive, from the network device, a second GNSS measurement parameter including a second GNSS measurement gap; and
perform, while in a radio resource control (RRC) connected mode, a GNSS measurement based on the received second GNSS measurement parameter, for acquiring a valid GNSS new position fix; and
an interface coupled with the one or more processors to enable communication.

35. The apparatus of claim 34, wherein to perform the GNSS measurement based on the received second GNSS measurement parameter the one or more processors are to determine a time slot gap between a starting time of the on-duration period of a C-DRX cycle and an end time of the second GNSS measurement gap in a second GNSS measurement periodicity included in the second GNSS measurement parameter, wherein the second GNSS measurement gap is just before the on-duration period of the C-DRX cycle, and the one or more processors are further to:
in accordance with a determination that the time slot gap is smaller than a predefined threshold, perform the GNSS measurement within the second GNSS measurement gap in the second GNSS measurement periodicity; and
in accordance with a determination that the time slot gap is not smaller than the predefined threshold, perform an additional GNSS measurement just before the on-duration period of the C-DRX, wherein the additional GNSS measurement is not the GNSS measurement in the second GNSS measurement periodicity.

36. The apparatus of claim 35, wherein the additional GNSS measurement is triggered by paging information including an indication of triggering the additional GNSS measurement, and wherein the one or more processors are further to: receive the paging information from the network device.

37. The apparatus of claim 35, wherein the additional GNSS measurement is triggered by the starting time of the on-duration period of a C-DRX cycle such that the additional GNSS measurement is performed during a sleep period in a previous C-DRX cycle and completed just before the starting time of the on-duration period of the C-DRX cycle.

38. The apparatus of claim 35, wherein the one or more processors are further to:
compare the on-duration period of a C-DRX cycle with a duration of the second GNSS measurement periodicity, and
wherein to perform the GNSS measurement based on the received second GNSS measurement parameter the one or more processors are to:
in accordance with a determination that the on-duration period of the C-DRX cycle is greater than the duration of the second GNSS measurement periodicity, shift the second GNSS measurement gap within the on-duration period of the C-DRX based on the additional GNSS measurement gap.

39. The apparatus of claim 35, wherein the GNSS measurements in the remaining second GNSS measurement periodicities within a sleep period of a C-DRX cycle are suspended when the time slot gap is smaller than the predefined threshold.

40. The apparatus of claim 35, wherein the GNSS measurements in the second GNSS measurement periodicities within a sleep period of a C-DRX cycle are suspended when the time slot gap is not smaller than the predefined threshold.

41. The apparatus of claim 34, wherein the one or more processors are further to:
compare an on-duration period of a C-DRX cycle with a duration of a second GNSS measurement periodicity included in the second GNSS measurement parameter, and
wherein to perform the GNSS measurement based on the received second GNSS measurement parameter the one or more processors are to:
in accordance with a determination that the on-duration period of the C-DRX cycle is greater than the duration of the second GNSS measurement periodicity, perform the GNSS measurement periodically within the on-duration period of the C-DRX based on the second GNSS measurement gap and the second GNSS measurement periodicity.

42. One or more non-transitory, computer-readable media having instructions that, when executed, cause one or more processors to:
generate, for transmission to a user equipment (UE), an indication of one or more Global Navigation Satellite System (GNSS) measurement parameters including a GNSS measurement gap; and
generate, for transmission to the UE, a trigger for a GNSS measurement.

43. The one or more non-transitory, computer-readable media of claim 42, wherein the one or more GNSS measurement parameters further comprise a GNSS measurement periodicity and a subframe offset, and wherein the GNSS measurement is to be performed based on the GNSS measurement periodicity, the GNSS measurement gap, and the subframe offset.

44. The one or more non-transitory, computer-readable media of claim 42 or 43, wherein the instructions, when executed, further cause the one or more processors to generate a Medium Access Control (MAC) Control Element (CE) with the indication of the one or more GNSS measurement parameters and the trigger.
